(19) United States
(12) Patent Application Publication
(10) Pub. No.: US 2017/0269186 A1
(43) Pub. Date: Sep. 21, 2017

(54) LOCALIZATION SYSTEM COMPRISING MULTIPLE BEACONS AND AN ASSIGNMENT SYSTEM

(71) Applicant: PHILIPS LIGHTING HOLDING B.V., EINDHOVEN (NL)

(72) Inventors: SAHIL SHARMA, EINDHOVEN (NL); OSCAR GARCIA MORCHON, AACHEN (DE); FULONG MA, SHANGHAI (CN)

(73) Assignee: Philips Lighting Holding B.V., Eindhoven (NL)

(21) Appl. No.: 15/505,769

(22) PCT Filed: Aug. 24, 2015
(86) PCT No.: PCT/EP2015/069321

§ 371 Date: Feb. 22, 2017

(30) Foreign Application Priority Data
Aug. 22, 2014 (EP) 14181901.1

(51) Int. Cl. G01S 1/70; H04B 10/50; H04L 29/06; H04B 1/3827

(52) U.S. Cl. CPC G01S 1/70; H04B 1/3833; H04B 10/502; H04L 63/068; H04L 63/0492

(57) ABSTRACT

A localization system 100 comprising multiple beacons 120 and an assignment system 110 is provided. The assignment system is arranged to assign a temporary location identifier to a location identifier associated with a beacon. A scheduler 150 is arranged to schedule the assigning of temporary location identifiers according to a schedule. It is avoided that the beacons have a fixed location identifier, thus third parties cannot create a mapping between the temporary location identifiers and the locations of the beacons.

### FIELD OF THE INVENTION

The invention relates to a localization system comprising multiple beacons. The invention further relates to an assignment system, a localization method, a computer program and a computer readable medium.

### BACKGROUND

International Patent Application WO2013016439 A1 with title “Self identifying modulater light source”, included herein by reference, discloses a known localization system.

In the known system a mobile device receives light from a LED light source. The LED light source can be any lighting source used for general purpose, spot illumination, or backlighting. The light is a modulated LED light source, and is part of the visible electromagnetic wireless spectrum. LEDs are digital devices which can be rapidly switched on and off, to send signals above the rate which the human eye can see. By modulating the LEDs, turning them on and off rapidly, one can send digital information that is unperceivable to the human eye, but is perceivable by image sensors. Modulation techniques include “On Off Keying” (OOK) and “Digital Pulse Recognition” (DPR).

The Mobile device can be a smart mobile device and is most commonly found in the form of mobile phones, tablets, and portable laptop computers. The Mobile device comprises a camera that captures a number of successive image frames and analyzes them to determine if a light source is providing information through light.

The reception of optically transmitted information may be used as an indoor positioning system. In a light-based positioning system, the physical locations of light sources can be used to approximate the relative position of the mobile device within line of sight. The mobile device can access a data source containing information about where the lights are physically located to determine position.

The LED light sources are continually broadcasting information. The information can include unique ID codes. The ID code can include location information in the ID code that provides a general indication of geographical location of the light. This geographical location information can be used to more quickly locate light source information that is used in determining indoor positioning on the mobile device. For example, the geographical information can point to a database to begin searching to find relevant information for positioning.

The ID code is static and is assigned during the calibration phase of the LED light source during the manufacturing process. Since the ID code is static, once it is assigned it will be forever associated locally to the specific LED light source.

### SUMMARY OF THE INVENTION

In the known system there is a fixed relationship between the location of a beacon and the identifier that it transmits. Even if the identifiers are arbitrary numbers, this allows a third party to build a map between transmitted identifiers and locations. For example, the third party may make an ‘app’ available for download which allows anybody to contribute identifier-location pairs to a database. Using crowdsourcing such a database would quickly be filled. This database would enable anyone to build applications using localization information.

The proprietor of the beacons has thus lost control over the use of its localization network. This is an undesirable situation, which makes investing in large scale localization services unattractive.

It would be advantageous to have an improved localization system that preserves the localization services for its proprietors.

A localization system as in claim 1 addresses this concern. The localization is for use with multiple beacons, and comprises an assignment system.

The assignment system comprises:

a storage arranged to store a list of multiple location identifiers associated with the multiple beacons, a beacon of the multiple beacons being associated with a location identifier of the multiple location identifiers, the location identifier associated with a beacon indicating a location in which the beacon is located,

a temporary location identifier unit arranged to assign a temporary location identifier to a location identifier of the list of location identifiers, the location identifier and the temporary location identifier having a relationship under control of the temporary location identifier unit, access to the relationship being restricted, the location identifier being recoverable from access to the temporary location identifier and the relationship,

a scheduler arranged to schedule said assigning of temporary location identifiers through the temporary location identifier unit according to a schedule,

a sender arranged to send the temporary location identifier to a beacon associated with the location identifier to which the temporary location identifier assigned over the first communication channel.

The scheduler ensures that once in a while each beacon receives a new temporary location identifier. An effort to map the identifiers transmitted by the beacons to fixed location is bound to fail, as this relationship changes. For example, the scheduler may cause each beacon to receive a new temporary location identifier each time a fixed time interval elapses, say after each hour; identifier-location pairs that are collected are thus invalidated.

The beacons may comprise:

a first receiver arranged to receive a temporary location identifier from the assignment system over the first communication channel between the beacon and the assignment system,

an identifier transmitter arranged to broadcast a wireless signal encoding the temporary location identifier in an area surrounding the beacon.

In particular, a light source as described in the known art may be adapted for use in an embodiment of the localization system.

The assignment system, beacons and mobile devices are electronic devices. The assignment system may be one or more servers, etc. The beacons may be luminaires, Wi-Fi routers, street lights, etc. The mobile devices may be mobile phones, tablets, etc.

The localization system as described herein may be applied in a wide range of practical applications. Such practical applications include: indoor navigation, localized advertisement, localized information, tracking of mobile devices, etc.

An aspect of the invention concerns a localization method.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer.

In a preferred embodiment, the computer program comprises computer program code means adapted to perform all the steps of a method according to the invention when the computer program is run on a computer. Preferably, the computer program is embodied on a computer readable medium.

### BRIEF DESCRIPTION OF THE DRAWINGS

These and other aspects of the invention are apparent from and will be elucidated with reference to the embodiments described hereinafter. In the drawings,

FIG. 1a shows a schematic representation of a localization system 100 according to an embodiment,

FIG. 1b shows a schematic representation of a detail of localization system 100′ according to an embodiment,

FIG. 1c shows a schematic representation of a front view of a mobile phone according to an embodiment,

FIG. 1d shows a schematic representation of a back view of a mobile phone according to an embodiment,

FIG. 2 shows a schematic representation of a localization system 200 according to an embodiment,

FIG. 3a shows a schematic representation as a flow chart of a localization method according to an embodiment,

FIG. 3b shows a schematic representation as a flow chart of an assigning method according to an embodiment,

FIG. 3c shows a schematic representation as a flow chart of a broadcasting method according to an embodiment.

FIG. 4a shows a computer readable medium having a writable part comprising a computer program according to an embodiment,

FIG. 4b shows a schematic representation of a processor system according to an embodiment.

Items which have the same reference numbers in different figures, have the same structural features and the same functions, or are the same signals. Where the function and/or structure of such an item has been explained, there is no necessity for repeated explanation thereof in the detailed description.

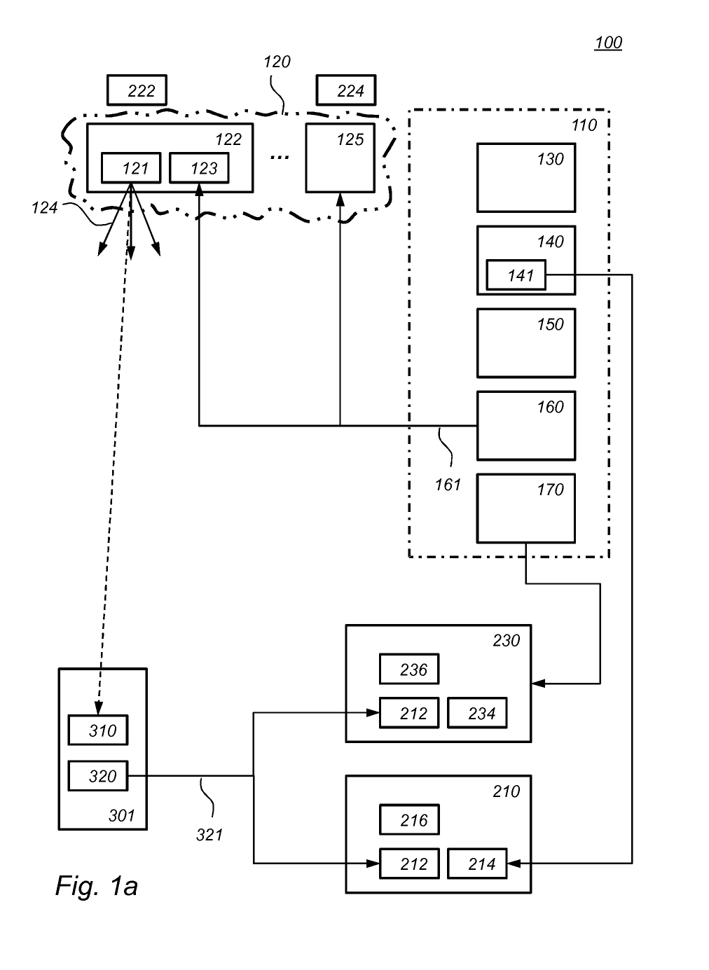

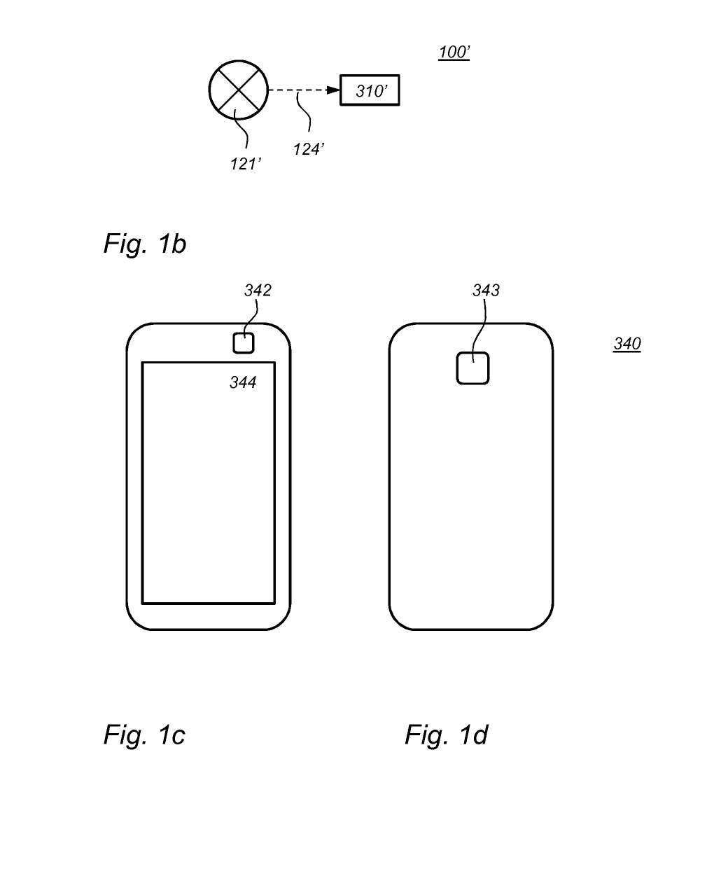

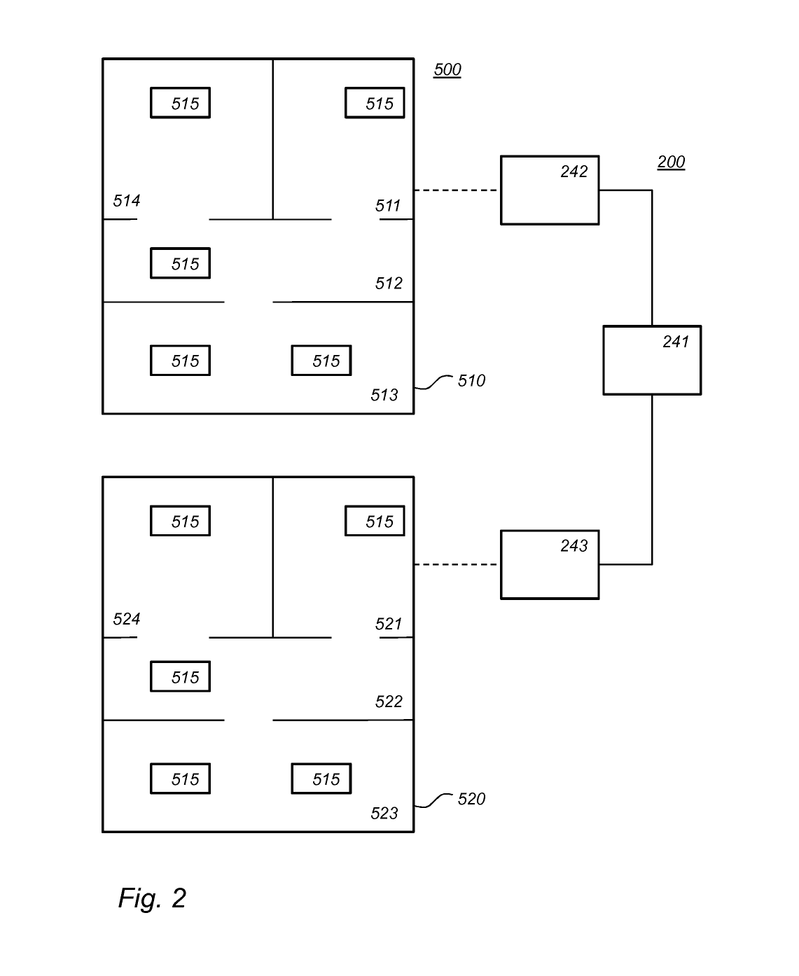

### LIST OF REFERENCE NUMERALS IN FIG. 1a-2

100 a localization system
110 an assignment system
120 multiple beacons
121 an identifier transmitter
121′ a light source
122, 125 a beacon
123 a first receiver
124 a wireless signal
124′ modulated light
130 a storage
140 a temporary location identifier unit
141 a relationship
150 a scheduler
160 a sender
161 a first communication channel.
170 an updating unit,
200 a localization system
210 a trusted localizer
212 a second receiver
214 a localizing unit
216 a device controller
222, 224 devices
230 an untrusted localizer
234 a localizing unit
236 a service unit
241 a first level computer
242, 243 a second level computer
301 a mobile device
310 a third receiver
310′ a camera
320 a computer network unit
321 a computer network connection
340 a mobile phone
342 a front camera
343 a back camera
344 a screen
500 a building
510 a first floor
520 a second floor
515 a beacon
511, 512, 513, 514 a room
521, 522, 523, 524 a room

### DETAILED DESCRIPTION OF EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

In the following, for sake of understanding, the localization system is described in operation. However, it will be apparent that the respective elements are arranged to perform the functions being described as performed by them.

FIG. 1a shows a schematic representation of a localization system 100 according to an embodiment.

Localization system 100 comprises multiple beacons 120 and an assignment system 110. Two beacons are shown of multiple beacons 120: beacons 122 and 125. Typically more beacons will be employed in localization system 100, e.g., more than 10, more than 100 or even more than 1000. The beacons may be distributed, say over multiple geographic areas. Beacons in the same area transmit a wireless signal identifying the area. Mobile devices that receive the wireless signal may use the wireless signal to localize the mobile device. The localization can be used for a number of purposes, for example, navigation, controlling devices in the area, receiving localized services, etc.

For example, beacons 122 and 125 may be located in different areas and transmit a different signal. If beacons 122 and 125 are located in the same area, they may transmit the same signal; this is not necessary though. From a reception of the signal, the location of the receiver of the signal may be deduced. In principle any one could use a receiver to obtain the signal and thus deduce its location. This situation is undesirable. There is a need for restricting access to localization services.

Beacon 122 is typical for all beacons in multiple beacons 120. Below a number of embodiments of beacons 122 are described. All of the multiple beacons 120 may be of the same design as beacon 122. On the other hand, different designs of beacons may be combined in a single embodiment of localization system 100.

Beacons of the multiple beacons 120 comprise a first receiver arranged to receive a temporary location identifier from the assignment system over the first communication channel between the beacon and the assignment system, and an identifier transmitter arranged to broadcast a wireless signal encoding the temporary location identifier in an area surrounding the beacon.

Beacon 122 comprises a first receiver 123 arranged to receive a temporary location identifier from assignment system 110 over the first communication channel 161 between beacon 122 and assignment system 110. Communication channel 161 may a computer network connection, e.g., an internet connection. For example, all or part of communication channel 161 may be wired connection, say an Ethernet connection; all or part of communication channel 161 may be a wireless connection, say a Wi-Fi connection. Alternatively other wireless RF links, such as Bluetooth®, Zigbee, Z-wave, 802.11s, or 802.15.4 could be used.

In an embodiment, communication channel 161 is arranged for single-directional communication from assignment system 110 to beacon 122; for example, the single-directional communication channel may be an Ethernet-over-power connection. For example, beacon 122 may comprise a computer network receiver for receiving a temporary identifier from assignment system 110, but not a computer network sender. This reduces cost of the beacon, which is important as multiple beacons are needed.

Beacon 122 comprises an identifier transmitter 121 arranged to broadcast a wireless signal 124 encoding the temporary location identifier in an area surrounding the beacon. The wireless signal may be received in an area surrounding beacon 122. For example, the wireless signal may be a radio signal. For example, identifier transmitter 121 may use so called radio frequency identification (RFID), e.g., comprising an active RFID tag configured to transmitting the temporary location identifier received from assignment system 110.

In an embodiment, part or all of multiple beacons 120 comprise a light source; for example these beacons may be luminaires. The light source in a beacon may be arranged for illuminating a surrounding area of the light source. In this case, the wireless signal is light emitted by the light source modulated by the identifier transmitter. Light modulated with information, in this case a temporary location identifier, is referred to as coded light. The localization system is well suited to encoding information in the light of a luminaire. The wireless signal may be a so-called coded light signal. The term coded light is generally used to refer to the light output of lighting systems that have a dual function; i.e. lighting systems that provide an illumination function and a communication function, by allowing the modulation of data on the light output in a manner that is substantially imperceptible to end users. Light sources are usually distributed in various spaces, e.g. indoor spaces, like offices, outdoor spaces, like parks etc. Arranging the light sources with a receiver 123 and transmitter 121, e.g. a modulator for modulating the light of the light source provides the lighting system with an additional functionality. In this embodiment, the wireless signal is light emitted by the light source modulated, say by a modulator comprised in the beacon to encode the temporary location identifier. At the same time, the light source may illuminate a surrounding area of the light source. The light source may be any light source that may be modulated fast enough without human observers noticing the modulation, e.g., LED light sources. In an embodiment, the temporary location identifier is encoded in the visible light of the light source. See the art cited in the background for examples.

Wireless signal 124 may be received by a mobile device. FIG. 1a shows as an example, mobile device 301. Multiple mobile devices may receive the same wireless signal. Mobile device 301 comprises a third receiver 310 arranged to wirelessly receive a temporary location identifier broadcasted by a beacon. Mobile device 301 receiving wireless signal 124 has been indicated in FIG. 1a with a dashed line from beacon 122 to mobile device 301.

For example, if the wireless signal is a radio signal, mobile device 301 may comprise a radio signal receiver. For example, if the wireless signal is coded light, mobile device 301 may comprises a camera. If the system uses different types of wireless signals, mobile device 301 may comprise multiple types of receivers; for example, mobile device 301 may comprise a radio signal receiver and a camera. Mobile device 301 is arranged to obtain the temporary location identifier from received wireless signal 124. For example, mobile device 301 may comprise a demodulator arranged to obtain a temporary location identifier from the received wireless signal. In case a radio signal is used, a radio demodulator may be used; in case of coded light, a light demodulator is used, etc. Demodulation may be done in hardware or software. Coded light is suited for demodulation in software. For example, demodulation of received coded light may be done by executing software, say an app, arranged to demodulate received coded light.

It will be clear to those skilled in the art of coded light system design that instead of using a camera, which is present on most smart-phones and thus provides a very favorable embodiment for localization, it may also be possible to use other light sensing means, such as one or more photodiodes. Such photodiodes may be integrated in the mobile devices, or may be provided as an add-on to mobile devices, such as mobile phones and/or tablets. Photodiodes may for example provide light sensing functionality, in that one or more photo-diodes with suitable optics may be coupled to a circuit that can be connected to a 3.5 mm audio jack suitable for use with the mobile phone microphone input, thereby re-purposing the microphone input on the mobile device for coded light detection.

Mobile device 301 may use the temporary location identifier in several ways. For example, in a tracking application, mobile device 301 may store the temporary location identifier in a storage, say a memory of mobile device 301, together with a timestamp. The temporary location identifier and timestamp may later be used to reconstruct where the mobile device has been and where.

Mobile device 301 may comprise a computer network unit for communication with, e.g., a trusted or untrusted localizer. These are further explained below. For example, computer network unit 320 may be a Wi-Fi unit, a GPRS, UMTS unit etc. The computer network may be the Internet. The computer network connection 321 connects mobile device 301 with one or more of untrusted localizer 230 and trusted localizer 210.

Assignment system 110 comprises a storage 130, a temporary location identifier unit 140, a scheduler 150, and a sender 160. Storage 130 may be integrated with temporary location identifier unit 140. Storage 130, a temporary location identifier unit 140, a scheduler 150, and a sender 160 may be combined in a single device, or split over multiple devices.

Storage 130 is arranged to store a list of multiple location identifiers. Each beacon of the multiple beacons is associated with a location identifier of the multiple location identifiers. In an embodiment, the location identifiers uniquely identify the associated beacon in the multiple beacons. The latter is not strictly necessary though; for example, beacons that are located in the same area, and are arranged to transmit the same temporary location identifiers may be associated with a same location identifier. Conversely, light beacons with the same location ID may send out different temporary location identifiers, e.g., depending on the parameters provided to a function that maps location identifier to temporary location identifier.

The location identifier associated with a beacon indicates a location in which the beacon is located. For example, beacons may be assigned an arbitrary location identifier, say a serial number, and storage 130 may store a location for each location identifier. On the other hand, the location identifier may indicate a location themselves, e.g., coordinates, a location on a map, as a room number, etc. Access to the location identifiers is restricted. In an embodiment, the location identifiers are not sent to the beacons, although other embodiments may use location identifiers to address beacons via broadcast messages. Nevertheless, also in the latter embodiments, the location identifiers are not transmitted in the wireless signal.

The location identifiers are not transmitted by the beacons. In an embodiment, the location identifiers are secret and access to the location identifiers is controlled. In an embodiment, location identifiers are visible at the beacon, say in the form of a sticker. The latter options ease maintenance of the beacons, whereas wholesale access to the localization system by unauthorized users and/or service providers is still avoided as the location identifiers is not transmitted in the wireless signal.

Temporary location identifier unit 140 is arranged to assign a temporary location identifier to a location identifier of the list of location identifiers. The location identifier and the temporary location identifier have a relationship 141 under control of the temporary location identifier unit. The location identifier is recoverable from access to the temporary location identifier and the relationship.

Access to the relationship is restricted. For example, the relationship is known in the assignment system, and trusted servers, e.g., a trusted localizer.

There are several ways to assign a temporary location identifier to a location identifier.

For example, the temporary location identifier may be obtained from the location identifier by applying a cryptographic method under control of one more cryptographic keys to the location identifier, possibly together with one or more nonces. For example, the cryptographic method may comprise applying a keyed hash to the location identifier and possibly a nonce, under control of a key.

In formula form, we use Lᵢ to indicate the i-th one of the location identifiers; Tᵢ as the temporary location identifier assigned to location identifier Lᵢ. Location identifier Lᵢ may also uniquely identify a beacon, but this is not needed; K is a secret key; N is a nonce. For example, a temporary location identifier unit may be arranged to compute Tᵢ=F_{K}(Lᵢ,N). The function F is a cryptographic function, that generates a bit-sequence, say a byte, a word, etc., that is not easy to predict without knowing all the inputs and the key. The function F may be a so-called Pseudo Random Function (PRF). An ideal PRF is indistinguishable from a truly Random Function. Using nonces ensures that new temporary location identifiers are computed when the computation is repeated; instead of nonces also the key may be changed, say incremented, or replaced. A nonce may be a timestamp.

For example, F may be or comprise a keyed hash function, for example HMAC. For example, F may be an encryption function, say a block cipher, say AES. In an embodiment, the bit size of the output of F is the same as the bit size of the temporary location identifiers used by the beacons. For example, if the beacons use 8 or 16 or 32 bit sized temporary locations identifiers, etc., the function F may have as output 8 or 16 or 32 bits, etc. The function may comprise or be combined with a function to restrict the number of bits in the outputs, say bits may be discarded, a modulo operation; mod 2̂8, 2̂16, 2̂32, etc.

Representation 141 may comprise the one or more secret keys, e.g., K, and the nonce or nonces if these are used. Access to the nonces need not be kept secret, for example, the nonces may be public, e.g., accessible from a web-site, etc. However, access to the key or keys is restricted. In an embodiment, the relationship is digitally represented, said digital representation comprising the one or more cryptographic keys.

In an embodiment, location identifiers are represented as bit-sequence having a bit-size. For example, the bit size may be 8, 16, 32 or other numbers, including non-powers of 2. The temporary location identifier unit may be arranged to select a random permutation mapping bit-sequences having the bit-size to bit-sequences having the bit-size. The random permutation may be true random permutation or pseudorandom permutation. In cryptography, the term pseudorandom permutation, abbreviated PRP, refers to a function that cannot be distinguished from a true random permutation (that is, a permutation selected at random with uniform probability, from the family of all permutations on the function's domain) with practical effort. For example, the pseudorandom function may be selected from a so-called pseudorandom permutation family, e.g., a collection of pseudorandom permutations. The temporary location identifier unit may be obtained by applying the random permutation to the location identifier. Using random permutation has the advantage, that location identifiers that are different are guaranteed to be assigned temporary location identifiers that are also different.

For example, if temporary location identifiers are 8 bits sequences, the temporary location identifier unit 140 may select a random permutation of the number 0-255. Selecting a random permutation may be done by selecting a random number in the range 1-256! and converting the random number to a permutation. Selecting the random number may use a pseudorandom function based on a seed. A different seed may be used, the next time a random permutation is needed; say the seed may be incremented. 256! refers to 256 faculty, i.e., the number of distinct permutations of the numbers 0-255.

In an embodiment, the temporary location identifier unit is arranged to select a random permutation of the multiple location identifiers, the temporary location identifier unit being assigned to a location identifier is the random permutation of said location identifier. For example, instead of using a cryptographic function, the location identifiers in the list of multiple location identifiers may be permuted. For example, in an embodiment, the temporary location identifier unit is arranged to select a random permutation of the multiple location identifiers. The temporary location identifier unit being assigned to a location identifier is the random permutation of said location identifier. For example, if 100 location identifiers of 8-bits are in use, e.g., on the list of storage 130, a random permutation of these 100 location identifiers may be assigned as temporary location identifiers.

The latter embodiment is especially suited to applications of localization system 100 in which the number of different location identifiers is close to the maximum number of different temporary location identifiers given the latter's bit-size; for example, if the temporary location identifiers are n-bits bit sequences and the number of different location identifiers equals 2̂n, or is close thereto. This embodiment can preserve reserved location identifiers, for example, the localization system may reserve some location identifiers for special purposes. For example, the system may be arranged so that the all-zero location identifier may not be used for any beacon, say make the system extendible in future. In the latter embodiment, the temporary location identifiers are drawn from the set of location identifiers in the list; accordingly, any location identifier that is not on the list will not be used, e.g., reserved location identifiers.

Scheduler 150 is arranged to schedule the assigning of temporary location identifiers through the temporary location identifier unit 140 according to a schedule. For example, scheduler 150 may run temporary location identifier unit 140 on the list of location identifiers in storage 130. The schedule may be to assign a temporary location identifier to a location identifier periodically, say after a time interval has elapsed. For example, a new temporary location identifier may be assigned to a location identifier every d time units, say every hour, or every day, etc. The schedule may also be more complicated, for example, some location identifiers may be assigned a new temporary location identifier more frequently than other location identifiers. For example, location identifiers located near location desirable for service providers, say store locations that sell expensive articles, say jewelry.

Sender 160 is arranged to send the temporary location identifier to a beacon associated with the location identifier to which the temporary location identifier assigned over the first communication channel. For example, sender 160 may comprise a computer network unit for communication over a computer network, say the internet; for example sender 160 may comprise a Wi-Fi unit. Sender 160 may be configured for Ethernet-over-power.

In an embodiment, localization system 100 comprises an optional trusted localizer 210. Trusted localizer 210 has access to relationship 141. For example, if relationship 141 is a list mapping temporary location identifiers to location identifiers, then trusted localizer 210 may have access to all or part of the list. For example, if relationship 141 comprises one or more cryptographic keys and/or nonces, then trusted localizer 210 may have access to all or part of the cryptographic keys and/or nonces. Trusted localizer 210 need not necessarily receive access to all of relationship 141 since trusted localizer 210 need not necessarily be responsible for localization across all of the multiple beacons. In an embodiment, trusted localizer 210 has access to all of relationship 141.

Trusted localizer 210 comprises a second receiver 212 and a localizing unit 214.

Second receiver 212 is arranged to receive a message from a mobile device over a computer network. The message comprises a temporary location identifier previously received by the mobile device. If a trusted localizer 210 is used in localizer system 210, then mobile device 301 may be arranged to send a message to trusted localizer 210 comprising a temporary location identifier received by the mobile device from a beacon, say beacon 122. The message may contain additional information, e.g., a command, etc., as further explained herein.

Localizing unit 214 is arranged to determine the location identifier to which the temporary location identifier is assigned from said received temporary location identifier and the relationship. For example, if the temporary location identifier has been obtained by encrypting a location identifier, possibly together with a nonce, under control of a cryptographic key, then localizing unit 214 may decrypt the temporary location identifier to obtain the location identifier, possibly discarding a nonce. For example, if the temporary location identifier has been obtained by applying a cryptographic method that is one-way, say a Pseudo Random Function (PRF), say a keyed hash, to a location identifier possibly together with a nonce. Then localizing unit 210 may obtain the location identifier, by applying the cryptographic method to all location identifiers together with the nonce and verifying which application result in the received temporary location identifier.

Temporary location identifier unit 140 may be arranged to keep a list of location identifiers together with the assigned temporary location identifier, even if a cryptographic method was used. In an embodiment, trusted localizer 210 receives one or more pairs of location identifiers and assigned temporary location identifiers. The latter avoids the need to shares keys.

The trusted localizer is well suited for integration with assignment system 110.

In an embodiment, localization system 100 comprises an optional untrusted localizer 230. Untrusted localizer 230 comprises a second receiver 212, and a localizer 234. Second receiver 212 is like trusted localizer 210. Localizer 210 may receive the same messages as localizer 230.

If untrusted localizer 230 is used, assignment system 100 may comprise an updating unit 170.

Updating unit 170 is arranged to send untrusted localizer 230 at least one obfuscated temporary location identifier, e.g., over the computer network, like the Internet. Updating unit 170 is arranged to obtain the obfuscated temporary location identifier corresponding to a location identifier by applying a cryptographic one-way function to the temporary location identifier assigned to the location identifier. A one-way function may be a cryptographic hash function.

The localizing unit 234 may be arranged to match the result of applying the cryptographic one-way function to a temporary location identifier obtained by a third receiver of a mobile device, with the obfuscated temporary location identifier. For example, the localizing unit 234 may have access to a pair of a location identifier and an obfuscated temporary location identifier. Localizing unit 234 has access to the one way function used to obtain the obfuscated temporary location identifier from the temporary location identifier. From the message the received temporary location identifier is obtained. The one-way function is applied to the received temporary location identifier. If the result is the same as the obfuscated temporary location identifier, then the localizing unit 234 has determined that has received the temporary location identifier from a beacon associated with the location identifier. The location identifier provided to untrusted localizer 230 may be any digital representation of the identifier, say, a position in a map, etc.

In an embodiment, the mobile device applies the one-way function to the temporary location identifier to obtain the obfuscated temporary location identifier, and sends the obfuscated temporary location identifier instead of the temporary location identifier to the untrusted localizer. The untrusted localizer needs only to check that an obfuscated temporary location identifier received from a mobile device is the same as an obfuscated temporary location identifier received from an updating unit.

In an embodiment, one or more obfuscated temporary location identifier are provided to the untrusted localizer, without also providing the corresponding location identifiers. This has the security advantage that the untrusted localizer need not have access to plain location identifier. For example, this may be applied to an untrusted localizer that provides one type of service, say advertisement for one brand of products. Whenever a user is in a location of products that sells products of the brand, possibly irrespective of what that product is, the untrusted localizer can verify that a mobile device is near to one of the locations in the one or more locations by checking if the obfuscated temporary identifier is in the set of obfuscated temporary identifier sent to the untrusted localizer by an updating unit.

Untrusted localizer 230 does not receive a list that maps temporary location identifiers to location identifiers; thus untrusted localizer is prevented from publishing such a list on the internet, to enable others to perform the mapping from a temporary location identifier to a constant location identifier. Untrusted localizer also does not know what temporary localization identifiers are in use. The only way to obtain this information would be to manually go to the locations of the beacons to obtain this information; this prevents easy leaking of the temporary location identifiers—location identifier association. However, when a temporary location identifier is received from a mobile device 301, then the untrusted localizer is able to obtain the corresponding location identifier. Thus information on the location identifier is revealed to the untrusted localizer piecemeal and by chance, depending on a mobile device which happens to be in the location and sending the message. A different key may be used to compute the obfuscated temporary location identifier for different untrusted localizer, say in the keyed hash. This avoids collusion by untrusted localizers. Furthermore, the temporary location identifier and consequently the obfuscated temporary location identifier change on a periodic basis, thwarting attempts at collusion or gathering knowledge of location identifiers.

Even if all this information would be leaked to a third party, the third party could not start a localizing service which offers the same level of service as the untrusted localizer himself.

The words trusted and untrusted reflect whether or not the localizer has access to information that maps temporary location identifier to location identifiers, e.g., through access to temporary location identifier-location identifier pairs, and/or to access to the relationship. If a trusted localizer were to publish his information regarding the link between the identifiers, a competing localizer of the same capacity as the trusted localizer could be started.

A trusted localizer has access to information which it can use to map the temporary location identifiers (or a subset thereof) to location identifiers on a permanent basis. At any point an untrusted localizer may have information regarding part of the mapping, e.g., because mobile phones send the temporary location identifiers to an untrusted localizer, but this is a temporary mapping that changes as soon as the temporary location identifiers change.

A localizer, like trusted localizer 210 or untrusted localizer 230 may comprise a device controller 216 and/or a service unit 236. In FIG. 1a, trusted localizer 210 is shown with a device controller 216 and untrusted localizer 230 with a service unit 236. However, this may be the other way round, or a localizer may comprise both.

Device controller 216 may control one or more devices located near the beacons. For example, mobile device 301 may be configured to include a command in the message, together with the temporary location identifier. Device controller 216 is arranged to control devices in a location indicated by location identifier. For example, the devices may be climate control devices. The command may be a command to change the climate, e.g., increase/decrease the temperature, etc. In an embodiment, the beacons are luminaires with a light source, the wireless signal being coded light, the device controller 216 controlling the luminaires, e.g., the command may be a command to increase or decrease light output, e.g., dim the lights.

Device controller 216 uses the location identifier to select the correct device or devices for controlling. For example, FIG. 1a shows devices 222 and 224. If the location identifier of beacon 122 is obtained by the localizer, then device 222 is controlled, if the location identifier of beacon 125 is obtained by the localizer then device 224 is controlled.

A beacon, say a luminaire, may comprise an electronic copy of its associated location identifier. Device controller 236 may be configured to broadcast a message to the multiple beacons. The message may comprise the location identifier. Beacon 122 may be arranged to determine for a received message broadcasted to multiple beacons if the received message comprise the location identifier of stored at beacon 122; if beacon 122 act on a command comprised in the received message.

The Device controller may have access to an address of a device located near a beacon. For example, the address may be associated with the location identifier; the address may be an IP address, a URL, etc.

Service unit 236 provides a localized service to mobile device 301. In an embodiment, service unit 236 is configured to send a return message to mobile device 301. For example, servicing unit 236 may provide advertising relevant to the location, e.g. contained in the return message. For example, the return message may comprise a URL. The URL may point to information relevant to the location. For example, the beacon may be located to a store, or to tourist attraction, the return message may contain an advertisement, or information, etc. Servicing unit 236 may provide navigation instructions, e.g., how to get to a destination location from the location obtained from the location identifier.

Interestingly, mobile device 301 proves that it is actually at the location of the beacon by having knowledge of the temporary location identifier. Since the temporary location identifier changes, under control of the scheduler, the mobile device 301 cannot replay a temporary location identifier that it received earlier, e.g., at a previous visit to the location. This aspect is important for device controlling, since it is undesirable, if a user may control light or climate and the like from a different location, say as a prank. Only users who are actually near the device are allowed to control the devices. The same holds for servicing, for example, an advertiser who may want to send a coupon to a user who is not in his store, but may wish to avoid sending coupons to users who are already in his store. Note that, if desired, controlling of devices or servicing may be also constrained with additional conventional access control, e.g., password verification. The additional conventional access control may also include location based verification, e.g., verification of the IP address of mobile device as a check if the device is in the same network as the store.

The untrusted localizer may be comprised in the mobile device. In this case, there is no need to send the message over a computer network. For example, localizer 234 may be comprised in the mobile device. Updater 170 sends pairs of location identifiers and obfuscated temporary location identifiers to the mobile device directly. In this manner, a mobile device may be preprogrammed with a location, nevertheless the location is not revealed to the user until the mobile device arrives at the location. To avoid colluding, a different key may be used for different mobile devices to compute the one or more obfuscated temporary location identifiers. Preprogramming may be done by uploading to the mobile device, say by updater 170. This system may be used in advertising applications, dating applications, social networks, and the like.

FIG. 1b shows a schematic representation of a detail of localization system 100′ according to an embodiment. Localization system 100′ is the same as localization system 100, except that beacons are luminaries and the wireless signal is coded light. FIG. 1b shows a light source 121′, e.g. comprised in beacon 121, coded light 124′ and a camera 310′ of a mobile device, say mobile device 301. The camera is arranged to receive the coded light 124′. The mobile phone 301 may comprise a demodulator to obtain the temporary location identifier from the coded light received in the camera.

FIG. 1c shows a schematic representation of a front view of a mobile phone 340 according to an embodiment. FIG. 1d shows a schematic representation of a back view of a mobile phone according to an embodiment. Mobile phone 340 may be like mobile device 301 extended with camera's and phone capabilities.

Mobile phone 340 comprises a front camera 342, a back camera 343. Mobile phone may optionally comprise a screen 344, say a touch screen. Mobile phone 340 may comprise only a single camera. The camera functions as a receiver arranged to receive the modulated light from the light source.

Mobile phone 340 may store a software program, e.g. a so-called ‘app’ that performs a receiving function, obtaining the temporary location identifier, and possibly other information, from a received camera image, e.g. received by front or back camera 342 and 343. The software program may perform a message sending function, sending a message containing the temporary location identifier to trusted or untrusted localizer. The software may access an untrusted localizer on the mobile phone itself; the latter may be part of the same software or app.

Interestingly, the operation of the software program may be in the background. Images that are received on a camera are analyzed for temporary location identifiers. The user of the mobile phone need not be aware of this. Multiple temporary location identifiers may be obtained from a single camera simultaneously; for example, if multiple light sources of beacons are in view of the camera at the same time.

Encoding information in the light of light sources is known per se; see the art cited in the background.

Typically, beacon 122, assignment system 110 and mobile phone 301 each comprise a microprocessor (not shown) which executes appropriate software stored at the beacon 122, assignment system 110 and mobile phone 301; for example, that software may have been downloaded and/or stored in a corresponding memory, e.g., a volatile memory such as RAM or a non-volatile memory such as Flash (not shown). Alternatively, the beacon 122, assignment system 110 and mobile phone 301 may, in whole or in part, be implemented in programmable logic, e.g., as field-programmable gate array (FPGA). Beacon 122, assignment system 110 and mobile phone 301 may be implemented, in whole or in part, as a so-called application-specific integrated circuit (ASIC), i.e. an integrated circuit (IC) customized for their particular use.

FIG. 2 shows a schematic representation of a localization system 200 according to an embodiment.

The embodiment of localization system 200 has a more refined implementation of the temporary location identifier unit of the assignment system. The temporary location identifier unit comprises a first level computer and one or more second level computers.

The first level computer is arranged to apply a first cryptographic function to a location identifier of the list under control of a first cryptographic key, to obtain a corresponding first intermediate location identifier. For example, the first level computer may be arranged to apply the first cryptographic function to a combination of the location identifier and possibly a first nonce.

A second level computer is associated with a subset of the multiple location identifiers. The second level computer is arranged to apply a second cryptographic function to the first intermediate location identifier corresponding to a location identifier of the subset of location identifiers associated with the second level computer under control of a second cryptographic key. In this way a second intermediate location identifier is obtained. For example, the second level computers of the multiple second level computers may be arranged to apply the second cryptographic function to the first intermediate location identifier, possibly combined with a second nonce. Combining with a nonce may be done by concatenation.

The temporary location identifier unit is arranged to obtain the temporary location identifier from the second intermediate location identifier. For example, the second intermediate location identifier may be the temporary location identifier. There may also be more levels computers, e.g. a third level computer, etc.

In an embodiment, the same first nonce is used once for each location identifier of the list, and/or same second nonce is used once for each location identifier of the subset. It is not necessary to store all nonces. For example, a master nonce may be stored, e.g., by the first and/or second level computer. A nonce used to compute an individual temporary location identifier may be derived from the master nonce, e.g., using a Pseudo Random Function (PRF) with the master Nonce as key and some variable data as arguments. The variable data may be the location identifier itself.

A localization system that comprises a first level computer and multiple second level computers is suitable for use in a building 500. The second level computer may be associated with location identifiers of beacons in one or more areas of said building. For example, each second level computer may associated with location identifiers of beacons in a single floor of said multiple floors. If the beacons are luminaries the second level computers may also be device controller of the luminaires.

FIG. 2 also shows building 500. Shown are floors 510 and 520. In floor 510 are rooms 511-514 and in floor 520 are rooms 521-524. Beacons 515 are distributed around the building. Note that some rooms contain multiple beacons; these beacons may transmit the same temporary location identifier.

Generation of temporary location identifiers using a first level computer and second level computers need not be restricted to a building, but may be used to advantage for other situations as well. For example, street lights in a city may be under control of a first level computer, street lights in areas of the city, say for districts of the city, may be under control of a second level computer.

Below a possible embodiment of generating temporary location identifier using a first and level computer is presented. Generating the temporary location identifier for a beacon in a specific area may use a two-step process. The first level computer may compute a first intermediate location identifier as F_{K}_{₁}(L,Nonce_{d}). The function F may be a random temporary location identifier generation function. L is a location ID, which may be an identifier of the location in which the beacon is installed. This may be a room, floor or some other area, etc. Nonce_{d} is a number used once, say a random number, or a counter etc. The Nonce_{d} may be generated every d units of time. The key K₁ is a secret key that may be kept with the first level computer.

The function F generates an n-bit sequence of bits that is not easy to predict without knowing all the inputs, including the key. Function F may be realized as a keyed hash function (HMAC). The output of function F could be truncated to take only the b Least Significant Bits (LSB), etc. This operation can be done by taking the remainder of the output of function of F modulo 2^{b}.

A second level computer may compute the temporary location identifier as E_{K}_{₂}(IL,Nonceₜ), wherein IL is the first intermediate location identifier. Nonce is generated every t units of time. The key K₂ is another secret key that may also be kept with the first level computer or shared with a second level computer if the temporary location identifier generation is distributed between the first level computer and second level computer. The first intermediate and the nonce may be combined by concatenating.

The function E is a cryptographic function that may be realized with an encryption algorithm or by another keyed hash function, etc. This system may be extended to a third, fourth, . . . nth level computer.

The Location Id is never revealed in the clear during transmission of the beacons. Instead only a hash or encryption of the Location ID along with Nonce_{d} is obtained. This creates one level of mapping between first intermediate location identifiers and location identifiers. The second step creates a second mapping between first intermediate location identifiers and temporary location identifiers by performing the operation described in step 2. This step uses key K₂ which can be shared between the first level computer and a second level computer if the temporary location identifier generation is distributed between the two.

The first level computer may share shares a key Kᵢ with an untrusted localizer. The first level computer may perform the operation OWF_{Ki}(T) (One-Way-Function), wherein T is the temporary location identifier. The result of which is called an obfuscated temporary location identifier. All the obfuscated temporary location identifiers associated with the locations owned by the untrusted localizer may be mapped, on a location map and sent, say over a secure channel, to the untrusted localizer. The function OWF_{Ki}(ATPID) is a one way function, such as a keyed HMAC.

A possible sequence of event is the following:

a) The beacon is sent the temporary location identifier and it broadcasts it.
b) A mobile device reads this temporary location identifier and may send it back to the first level computer. The first level computer can verify location based on this.
c) The mobile device may also send the temporary location identifier to the untrusted localizer. Using Kᵢ, the untrusted localizer derives OWF_{Ki}(T) and checks its map to see if the result equals an obfuscated temporary location identifier which is associated with the locations owned by location first level computer. If it is, it may roll out its services.

Nonceₜ could be generated more frequently than Nonce_{d}, thus, allowing the second level mapping to change more frequently than the first level mapping. Since the mobile device cannot extract the Location ID, it cannot map the temporary location identifier to the Location ID. Furthermore, since temporary location identifier changes frequently, e.g. because Nonceₜ changes frequently, the mobile device does not have permanent temporary location identifiers. This avoids that the mobile device can create a map between temporary location identifiers and locations as leaking of such a mapping to external parties is not desirable.

The generation of temporary location identifiers could be distributed over different hardware. For instance, step 1 could be performed on the main first level computer, while step 2 could be performed on a second level computer. In the latter case Nonceₜ is known to the main first level computer.

In an alternate embodiment the first level computer sends out pairs of obfuscated temporary location identifiers and the corresponding location identifiers, possibly in the form of a map. The first level computer also sends out key Kᵢ for mobile device i. The first level computer initially uses this Kᵢ to compute the obfuscated temporary location identifier from a received temporary location identifier for mobile device i for the location. Thus different mobile device receive a different key Kᵢ, and thus have a different mapping between temporary location identifiers and obfuscated temporary location identifiers. The mobile device may compute obfuscated temporary location identifiers using Kᵢ, and checks to see if this obfuscated temporary location identifiers is associated with a locations for which it received a location identifier.

The temporary location identifiers need to be periodically changed. In the embodiment described above, two nonces are used to derive a temporary location identifier. In the first stage of temporary location identifier generation Nonce_{d} is used to create the first level of mapping. This nonce could be changed on a daily or monthly basis. In the second stage of temporary location identifier generation, Nonceₜ is used. This may be done more frequently and could be changed on an hourly of half hourly basis.

A fine balance needs to be obtained while changing Nonceₜ. On one hand, if a mobile device is in the same location, the mobile device need not read and transmit a temporary location identifier repeatedly within a time interval of t units. Instead, it reads the temporary location identifier once during the interval and sends the temporary location identifier only once with the first. This way, the device does not need to re-read and resend the temporary location identifier, saving the devices computation as well as the amount of data transmitted. On the other hand, to change the mapping between the first intermediate location identifier and the temporary location identifiers, the nonce would change and the device in such a case would have to re-read the temporary location identifier in order to authenticate its location credentials. Distributing the generation of temporary location identifier has the advantage that different locations could be under the administration of different second level computers. Each of these gateways could use different values of t. Codes for location in a shop that has high value items, such as consumer electronics, jewelry, etc., could change more frequently than other locations. Another extension to the scheme is that instead of having just 2 levels of mappings (Nonce_{d} and Nonceₜ), one can have N such mappings, with the first mapping changing every T1 time units, the second mapping every T2 time units, and so on, e.g., with T1>T2> . . . >TN.

Advantageous localization systems comprising a first and second level computer are defined in the claims. Applicant notes that advantageous localization systems with do not necessarily have a first and/or second level computer are set out in the following clauses. The Applicants hereby give notice that new claims may be formulated to such clauses and/or combinations of such clauses and/or features taken from the description, during prosecution of the present application or of any further application derived therefrom.

1. A localization system (100) for use with multiple beacons (120), the localization system comprising an assignment system (110), the assignment system comprising:

a storage (130) arranged to store a list of multiple location identifiers associated with the multiple beacons, a beacon of the multiple beacons being associated with a location identifier of the multiple location identifiers, the location identifier associated with a beacon indicating a location in which the beacon is located,

a temporary location identifier unit (140) arranged to assign a temporary location identifier to a location identifier of the list of location identifiers, the location identifier and the temporary location identifier having a relationship under control of the temporary location identifier unit, the location identifier being recoverable from access to the temporary location identifier and the relationship,

a scheduler (150) arranged to schedule said assigning of temporary location identifiers through the temporary location identifier unit according to a schedule, and

a sender (160) arranged to send the temporary location identifier to a beacon associated with the location identifier to which the temporary location identifier assigned over the first communication channel.

2. A localization system as in clause 1 comprising the multiple beacons,

a beacon of the multiple beacons comprising
a first receiver arranged to receive a temporary location identifier from the assignment system over the first communication channel between the beacon and the assignment system,
an identifier transmitter arranged to broadcast a wireless signal encoding the temporary location identifier in an area surrounding the beacon.
   3. A localization system as in clause 2, a beacon of the multiple beacons comprising a light source, the light source being arranged for illuminating a surrounding area of the light source, the wireless signal being light emitted by the light source modulated by the identifier transmitter.
   4. A localization system as in any one of the preceding clauses, wherein the temporary location identifier unit of the assignment system comprises a first level computer arranged to apply a first cryptographic function to a location identifier of the list under control of a first cryptographic key, to obtain a corresponding first intermediate location identifier, the temporary location identifier unit being arranged to obtain the temporary location identifier from the first intermediate location identifier, the first cryptographic key representing at least part of the relationship.
   5. A localization system as in any one of the preceding clauses, wherein the temporary location identifier unit of the assignment system comprises multiple second level computers, a second level computer being associated with a subset of the multiple location identifiers, a second level computer being arranged to apply a second cryptographic function to the first intermediate location identifier corresponding to a location identifier of the subset of location identifiers associated with the second level computer under control of a second cryptographic key, to obtain a second intermediate location identifier, the temporary location identifier unit being arranged to obtain the temporary location identifier from the second intermediate location identifier.
   6. A localization system as in clause 4 or 5, wherein

the first level computer is arranged to apply the first cryptographic function to a combination of the location identifier and a first nonce, and/or

a second level computer of the multiple second level computers is arranged to apply the second cryptographic function to a combination of the first intermediate location identifier and the second nonce.

7. A localization system as in clause 5 or 6, wherein the multiple beacons are arranged in a building, the multiple second level computers being associated with location identifiers of beacons in multiple corresponding areas of said building.
8. A localization system as in any one of the preceding clauses wherein the relationship is digitally represented, said digital representation comprising one or more cryptographic keys.
9. A localization system as in any one of clauses 1, 2, and 3, wherein location identifiers of the multiple location identifiers are represented as a bit-sequence having a bit-size, the temporary location identifier unit being arranged to select a random permutation mapping bit-sequences having the bit-size to bit-sequences having the bit-size, the temporary location identifier unit being assigned to a location identifier is the random permutation of said location identifier.
10. A localization system as in any one of the preceding clauses, comprising a trusted localizer, the trusted localizer having access to the relationship, the trusted localizer comprising:

a second receiver arranged to receive a message from a mobile device over a computer network, the message comprising a temporary location identifier previously received by the mobile device, the mobile device comprising a third receiver arranged to wirelessly receive a temporary location identifier broadcasted by a beacon,

a localizing unit arranged to determine the location identifier to which the temporary location identifier is assigned from said received temporary location identifier and the relationship.
11. A localization system as in clause 10, wherein the trusted localizer comprises a device controller, the message comprising a command, the device controller being arranged to control devices in a location indicated by location identifier.
12. A localization system as in any one of the preceding clauses, comprising an untrusted localizer,

the assignment system comprising an updating unit, the updating unit being arranged to send the untrusted localizer at least one obfuscated temporary location identifier, the updating unit being arranged to obtain the obfuscated temporary location identifier corresponding to a location identifier by applying a cryptographic one-way function to the temporary location identifier assigned to the location identifier,

the untrusted localizer comprising a

a localizing unit arranged to match the result of applying the cryptographic one-way function to a temporary location identifier obtained by a third receiver of a mobile device, with the obfuscated temporary location identifier.

13. A localization system as in clause 12, wherein

the updating unit is arranged to send the untrusted localizer at least one location identifier corresponding to the obfuscated temporary location identifiers, the localizing unit being arranged to determine the location identifier corresponding to the result of applying the cryptographic one-way function to the received temporary location identifier.

14. A localization system as in clause 12 or 13, wherein the untrusted localizer is comprised in the mobile device.
15. An assignment system comprising:

a storage arranged to store a list of multiple location identifiers associated with the multiple beacons, a beacon of the multiple beacons being associated with a location identifier of the multiple location identifiers, the location identifier associated with a beacon indicating a location in which the beacon is located,

a temporary location identifier unit arranged to assign a temporary location identifier to a location identifier of the list of location identifiers, the location identifier and the temporary location identifier having a relationship under control of the temporary location identifier unit, the location identifier being recoverable from access to the temporary location identifier and the relationship,

a scheduler arranged to schedule said assigning of temporary location identifiers through the temporary location identifier unit according to a schedule,

a sender arranged to send the temporary location identifier to a beacon associated with the location identifier to which the temporary location identifier assigned over the first communication channel.

16. A localization method (410) for use with multiple beacons and an assignment system, the localization method comprising

storing (411) a list of multiple location identifiers associated with the multiple beacons, a beacon of the multiple beacons being associated with a location identifier of the multiple location identifiers, the location identifier associated with a beacon indicating a location in which the beacon is located,

assigning (412) a temporary location identifier to a location identifier of the list of location identifiers, the location identifier and the temporary location identifier having a relationship under control of the temporary location identifier unit, the location identifier being recoverable from access to the temporary location identifier and the relationship,

scheduling (413) the assigning of temporary location identifiers according to a schedule, and

sending (414) the temporary location identifier to a beacon associated with the location identifier to which the temporary location identifier assigned over the first communication channel.

17. A localization method as in clause 16, comprising:

receiving (431) in a beacon of multiple beacons a temporary location identifier from the assignment system over a first communication channel between the beacon and the assignment system, and

broadcasting (432) a wireless signal encoding the temporary location identifier in an area surrounding the beacon.

18. A computer program comprising computer program code means adapted to perform all the steps of clause 16 when the computer program is run on a computer.
19. A computer program as in clause 18 embodied on a computer readable medium.

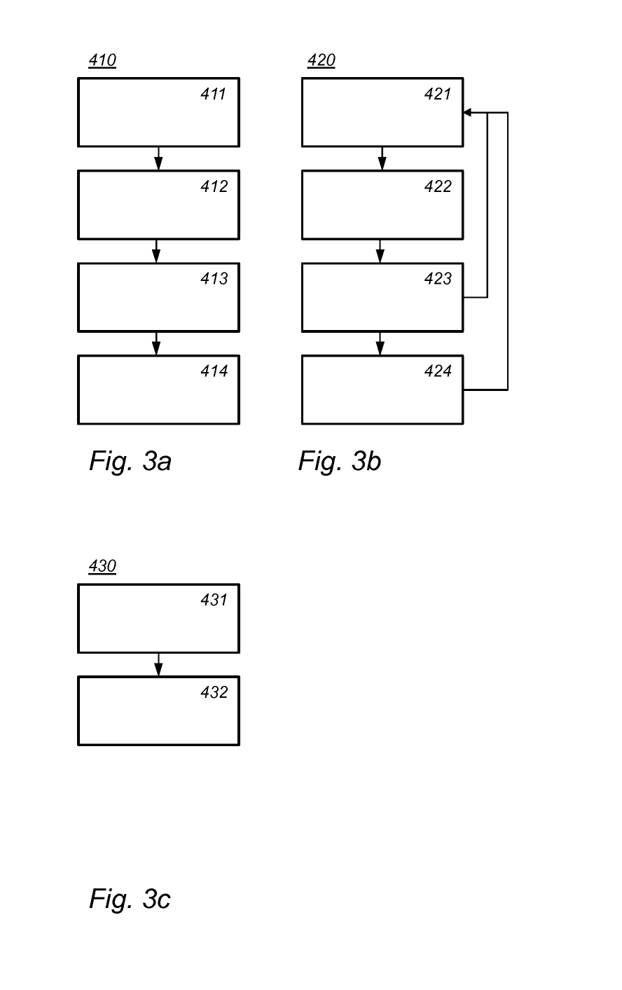

FIG. 3a shows a schematic representation as a flow chart of a localization method 410 according to an embodiment. Localization method 410 comprises:

storing 411 a list of multiple location identifiers associated with the multiple beacons, a beacon of the multiple beacons being associated with a location identifier of the multiple location identifiers, the location identifier associated with a beacon indicating a location in which the beacon is located,

assigning 412 a temporary location identifier to a location identifier of the list of location identifiers, the location identifier and the temporary location identifier having a relationship under control of the temporary location identifier unit, access to the relationship being restricted, the location identifier being recoverable from access to the temporary location identifier and the relationship,

scheduling 413 the assigning of temporary location identifiers according to a schedule,

sending 414 the temporary location identifier to a beacon associated with the location identifier to which the temporary location identifier assigned over the first communication channel.

FIG. 3b shows a schematic representation as a flow chart of an assigning method 420 according to an embodiment. Assigning 412 may use assign method 420. Assigning method 420 comprises:

selecting 421 a location identifier. For example, a location identifier may be selected from a stored list.

assigning 422 a temporary location identifier to the location identifier. For example, a nonce may be chosen or computed. A cryptographic function or method may be applied to a combination, say a concatenation, of the location identifier and the nonce.

deciding 423 if more location identifiers are left to assign, if the method continues at 421.

scheduling 424, if the a new temporary identifier is to be assigned according to the schedule, the method continues again at 421.

FIG. 3c shows a schematic representation as a flow chart of a broadcasting method 430 according to an embodiment. Broadcasting method may be used by a beacon, and may be part of a localization method. Broadcasting method 430 comprises:

receiving 431 in a beacon of multiple beacons a temporary location identifier from the assignment system over a first communication channel between the beacon and the assignment system,

broadcasting 432 a wireless signal encoding the temporary location identifier in an area surrounding the beacon.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. Moreover, a given step may not have finished completely before a next step is started.

A method according to an embodiment may be executed using software, which comprises instructions for causing a processor system to perform methods 410, 420 or 430. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server. A method may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to an embodiment. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

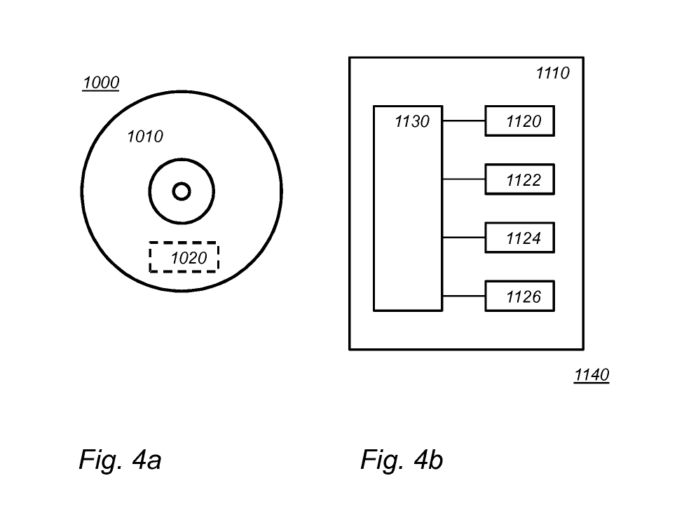

FIG. 4a shows a computer readable medium 1000 having a writable part 1010 comprising a computer program 1020, the computer program 1020 comprising instructions for causing a processor system to perform a method according to an embodiment, say method 410, 420 and/or 430. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. In an embodiment, the computer program 1020 comprises instructions for causing a processor system to perform said method of assigning temporary location identifiers.

FIG. 4b shows a schematic representation of a processor system 1100 according to an embodiment of an assignment system. The processor system comprises one or more integrated circuits 1110. The architecture of the one or more integrated circuits 1110 is schematically shown in FIG. 4b. Circuit 1110 comprises a processing unit 1120, e.g. a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A localization system for use with multiple beacons, the localization system comprising an assignment system, the assignment system comprising:
a storage arranged to store a list of multiple location identifiers associated with the multiple beacons, a beacon of the multiple beacons being associated with a location identifier of the multiple location identifiers, the location identifier associated with a beacon indicating a location in which the beacon is located,
a temporary location identifier unit arranged to assign a temporary location identifier to a location identifier of the list of location identifiers, the location identifier and the temporary location identifier having a relationship under control of the temporary location identifier unit, the location identifier being recoverable from access to the temporary location identifier and the relationship,
a scheduler arranged to schedule said assigning of temporary location identifiers through the temporary location identifier unit according to a schedule, and
a sender arranged to send the temporary location identifier to a beacon associated with the location identifier to which the temporary location identifier assigned over the first communication channel, wherein
the temporary location identifier unit of the assignment system comprises a first level computer arranged to apply a first cryptographic function to a location identifier of the list under control of a first cryptographic key, to obtain a corresponding first intermediate location identifier, the first cryptographic key representing at least part of the relationship, and wherein
the temporary location identifier unit of the assignment system comprises multiple second level computers, a second level computer being associated with a subset of the multiple location identifiers, a second level computer being arranged to apply a second cryptographic function to the first intermediate location identifier corresponding to a location identifier of the subset of location identifiers associated with the second level computer under control of a second cryptographic key, to obtain a second intermediate location identifier, the temporary location identifier unit being arranged to obtain the temporary location identifier from the second intermediate location identifier.

2. A localization system as in claim 1 comprising the multiple beacons,
a beacon of the multiple beacons comprising:
a first receiver arranged to receive a temporary location identifier from the assignment system over the first communication channel between the beacon and the assignment system,
an identifier transmitter arranged to broadcast a wireless signal encoding the temporary location identifier in an area surrounding the beacon.

3. A localization system as in claim 2, a beacon of the multiple beacons comprising a light source, the light source being arranged for illuminating a surrounding area of the light source, the wireless signal being light emitted by the light source modulated by the identifier transmitter.

4. A localization system as in claim 1, wherein
the first level computer is arranged to apply the first cryptographic function to a combination of the location identifier and a first nonce, and
a second level computer of the multiple second level computers is arranged to apply the second cryptographic function to a combination of the first intermediate location identifier and the second nonce.

5. A localization system as in claim 1, wherein the multiple beacons are arranged in a building, the multiple second level computers being associated with location identifiers of beacons in multiple corresponding areas of said building.

6. (canceled)

7. A localization system as in claim 1, wherein location identifiers of the multiple location identifiers are represented as a bit-sequence having a bit-size, the temporary location identifier unit being arranged to select a random permutation mapping bit-sequences having the bit-size to bit-sequences having the bit-size, the temporary location identifier unit being assigned to a location identifier is the random permutation of said location identifier.

8. A localization system as in claim 1, comprising a trusted localizer, the trusted localizer having access to the relationship, the trusted localizer comprising:
a second receiver arranged to receive a message from a mobile device over a computer network, the message comprising a temporary location identifier previously received by the mobile device, the mobile device comprising a third receiver arranged to wirelessly receive a temporary location identifier broadcasted by a beacon,
a localizing unit arranged to determine the location identifier to which the temporary location identifier is assigned from said received temporary location identifier and the relationship.

9. A localization system as in claim 8, wherein the trusted localizer comprises a device controller, the message comprising a command, the device controller being arranged to control devices in a location indicated by location identifier.

10. A localization system as in claim 1, comprising an untrusted localizer,
the assignment system comprising an updating unit, the updating unit being arranged to send the untrusted localizer at least one obfuscated temporary location identifier, the updating unit being arranged to obtain the obfuscated temporary location identifier corresponding to a location identifier by applying a cryptographic one-way function to the temporary location identifier assigned to the location identifier,
the untrusted localizer comprising:
a localizing unit arranged to match the result of applying the cryptographic one-way function to a temporary location identifier obtained by a third receiver of a mobile device, with the obfuscated temporary location identifier.

11. A localization system as in claim 10, wherein
the updating unit is arranged to send the untrusted localizer at least one location identifier corresponding to the obfuscated temporary location identifiers, the localizing unit being arranged to determine the location identifier corresponding to the result of applying the cryptographic one-way function to the received temporary location identifier.

12. (canceled)

13. An assignment system comprising:
a storage arranged to store a list of multiple location identifiers associated with the multiple beacons, a beacon of the multiple beacons being associated with a location identifier of the multiple location identifiers, the location identifier associated with a beacon indicating a location in which the beacon is located,
a temporary location identifier unit arranged to assign a temporary location identifier to a location identifier of the list of location identifiers, the location identifier and the temporary location identifier having a relationship under control of the temporary location identifier unit, the location identifier being recoverable from access to the temporary location identifier and the relationship,
a scheduler arranged to schedule said assigning of temporary location identifiers through the temporary location identifier unit according to a schedule,
a sender arranged to send the temporary location identifier to a beacon associated with the location identifier to which the temporary location identifier assigned over the first communication channel, wherein
the temporary location identifier unit of the assignment system comprises a first level computer arranged to apply a first cryptographic function to a location identifier of the list under control of a first cryptographic key, to obtain a corresponding first intermediate location identifier, the temporary location identifier unit being arranged to obtain the temporary location identifier from the first intermediate location identifier, the first cryptographic key representing at least part of the relationship, and wherein
the temporary location identifier unit of the assignment system comprises multiple second level computers, a second level computer being associated with a subset of the multiple location identifiers, a second level computer being arranged to apply a second cryptographic function to the first intermediate location identifier corresponding to a location identifier of the subset of location identifiers associated with the second level computer under control of a second cryptographic key, to obtain a second intermediate location identifier, the temporary location identifier unit being arranged to obtain the temporary location identifier from the second intermediate location identifier.

14. A localization method for use with multiple beacons and an assignment system, the localization method comprising:
storing a list of multiple location identifiers associated with the multiple beacons, a beacon of the multiple beacons being associated with a location identifier of the multiple location identifiers, the location identifier associated with a beacon indicating a location in which the beacon is located,
assigning a temporary location identifier to a location identifier of the list of location identifiers, the location identifier and the temporary location identifier having a relationship under control of the temporary location identifier unit, the location identifier being recoverable from access to the temporary location identifier and the relationship,
scheduling the assigning of temporary location identifiers according to a schedule, and
sending the temporary location identifier to a beacon associated with the location identifier to which the temporary location identifier assigned over the first communication channel, wherein the assigning comprises:
applying a first cryptographic function to a location identifier of the list under control of a first cryptographic key, to obtain a corresponding first intermediate location identifier, the first cryptographic key representing at least part of the relationship, and
applying a second cryptographic function to the first intermediate location identifier corresponding to a location identifier of the subset of location identifiers associated with the second level computer under control of a second cryptographic key, obtaining a second intermediate location identifier, the temporary location identifier being obtained from the second intermediate location identifier.

15. A localization method as in claim 14, comprising:
receiving in a beacon of multiple beacons a temporary location identifier from the assignment system over a first communication channel between the beacon and the assignment system, and
broadcasting a wireless signal encoding the temporary location identifier in an area surrounding the beacon.

16. A computer program comprising computer program code means adapted to perform all the steps of claim 14 when the computer program is run on a computer.

17. A computer program as in claim 16 embodied on a computer readable medium.

18. A localization system as in claim 1, wherein the temporary location identifier unit is further arranged to also obtain the temporary location identifier from the first intermediate location identifier.

19. A localization method as in claim 14, wherein the temporary location identifier is further also obtained from the first intermediate location identifier.
